(19) United States
(12) Patent Application Publication
(10) Pub. No.: US 2018/0107991 A1
(43) Pub. Date: Apr. 19, 2018

(54) Mobile CheqPointe

(71) Applicant: Ovidio Rivera Chaparro, New London, CT (US)

(72) Inventor: Ovidio Rivera Chaparro, New London, CT (US)

(21) Appl. No.: 15/298,056

(22) Filed: Oct. 19, 2016

(51) Int. Cl. G06Q 20/04; G06Q 20/32

(52) U.S. Cl. CPC G06Q 20/042; G06Q 20/3223

(57) ABSTRACT

Mobile CheqPointe is a software application utilized separately or integrated, specific to the institution, as a feature to Mobile Check Depositing. Its purpose is to help reinforce check verification for personal or financial institutional use prior to mobile upload for deposit. Using a portable device, such as a mobile device with photographing capabilities and prior to depositing; a photograph is taken and uploaded into the application. Once a legible photo is captured, the software will then investigate to determine if any missing information or details pertinent to the paying bank are retrieved. Highlighted fields will indicate the error, then provide the customer with proper steps to ensure a non-returned bank draft. If the inspection, of all indicated fields on the check, has produced no results, then the check will be available for immediate deposit without error.

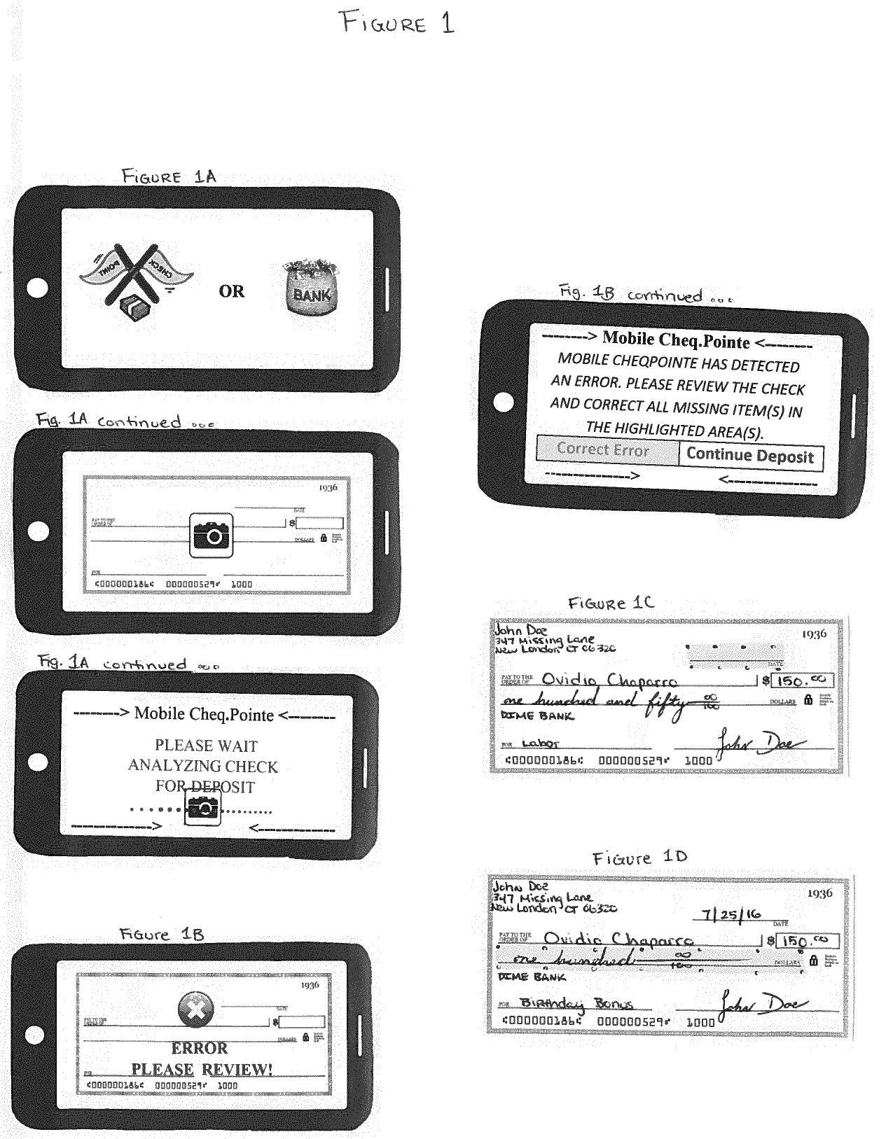

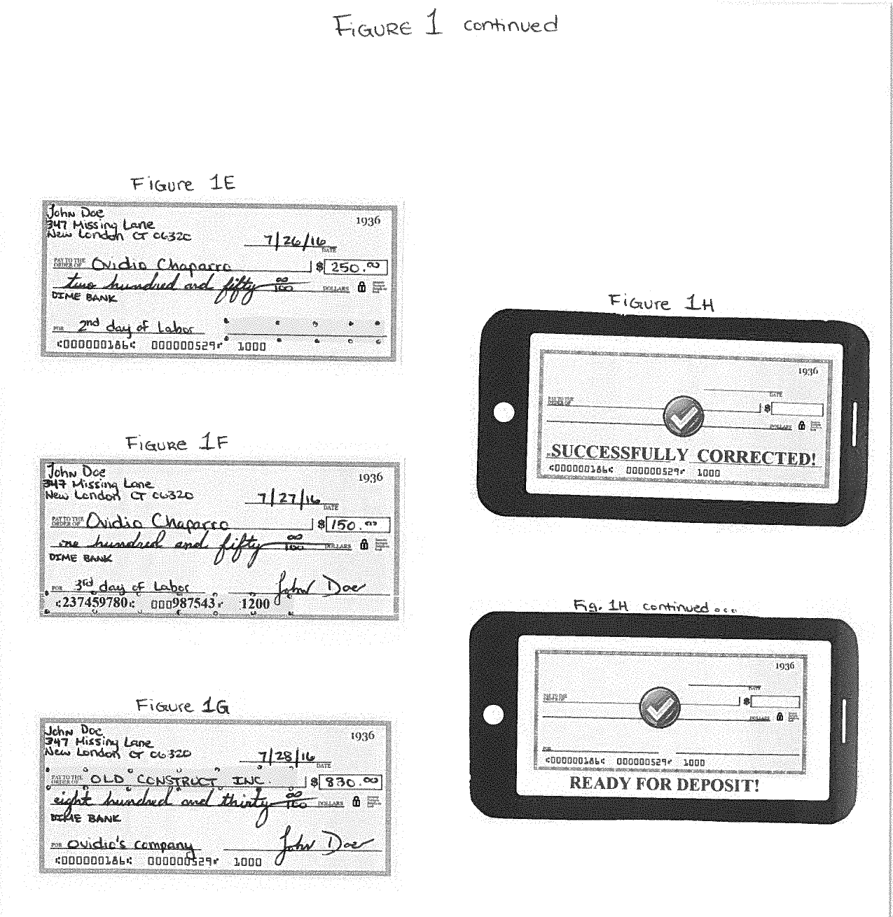

FIG. 1A. Enter application or integrated Mobile Check Deposit at current banking institution. Capture a legible photo of check (FIG. 1A continued) and select the scan button (FIG. 1A continued).

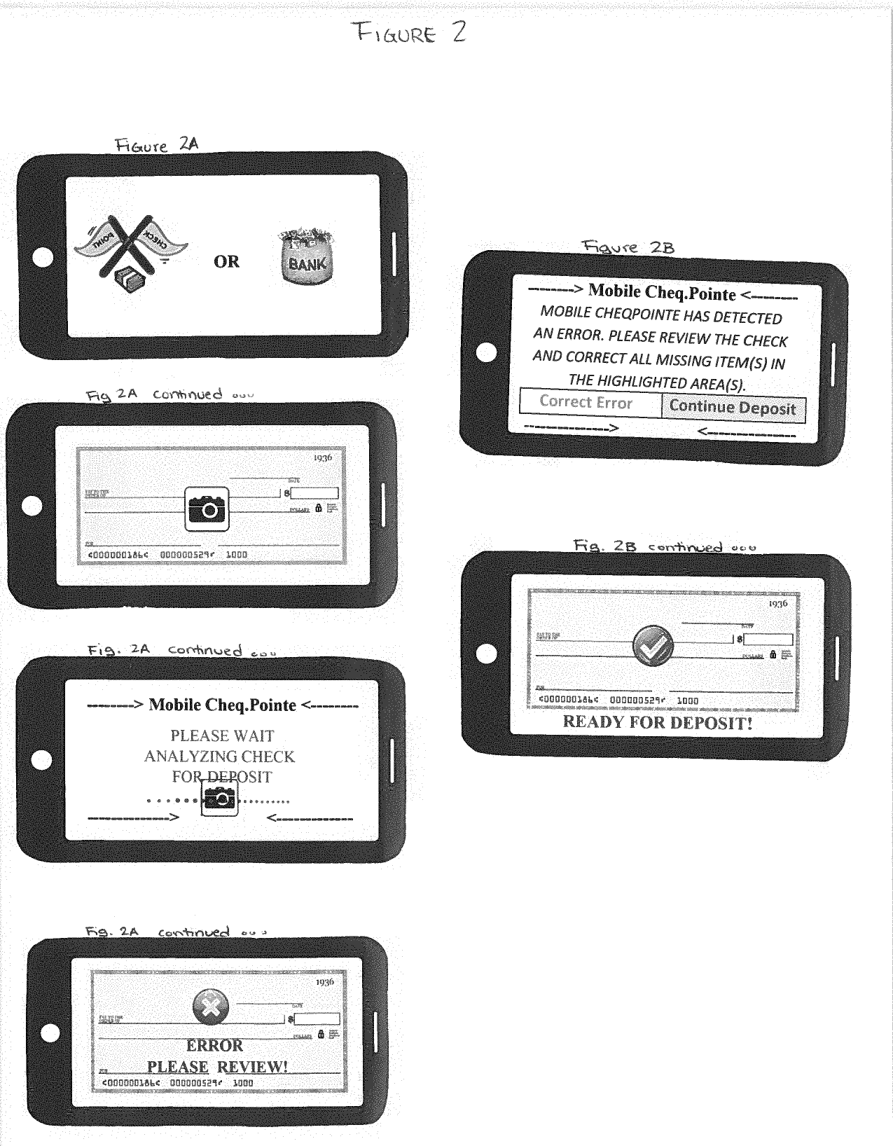

FIG. 1B. A warning will allow the consumer to acknowledge (FIG. 1B continued) any discrepancy and correct the error or an option to bypass (refer to FIG. 2B) the correction phase.

*Check Items in FIG. 1C through FIG. 1G will provide common human errors typically found by tellers at a financial institution.

FIG. 1C. Missing dates, postdated, or stale-dated checks will not be accepted.

FIG. 1D. The Legal Line and the Numerical Amount differ. All banks will accept the written amount on the legal line.

FIG. 1E. A missing endorsement by the maker of the check will not be accepted for deposit.

FIG. 1F. Routing number does not exist, which results in an unacceptable or fraudulent check.

FIG. 1G. Checks made payable to a business will not be accepted for deposit into a personal account.

FIG. 1H. Once the check is corrected it is “Ready for Deposit,” (FIG. 1H continued) ensuring that the paying bank will payout.

FIG. 2A. Enter application or integrated Mobile Check Deposit at current banking institution. Capture a legible photo of check (FIG. 2A continued) and select the scan feature (FIG. 2A continued). A warning will allow the consumer to acknowledge (FIG. 2A continued) any discrepancy.

FIG. 2B. Once the bypass button is selected, then the check is “Ready for Deposit” (FIG. 2B continued).

1. Ovidio R. Chaparro's specific contribution to Mobile CheqPointe is the ability to verify checks, prior to mobile deposit with any device containing imaging capabilities, through a series of inspections, typically visually examined by tellers at a financial institution, to aid in the correcting process once a captured photo transitions into an institutional deposit without incurring, including, but not limited to, returned item fees.
